(19) United States
(12) Patent Application Publication
(10) Pub. No.: US 2017/0300865 A1
(43) Pub. Date: Oct. 19, 2017

(54) UPDATING RECORDS BASED ON NETWORK RESOURCE INTERACTION

(71) Applicant: tilr corporation, New York City, NY (US)

(72) Inventors: Luke Vigeant, New York City, NY (US); Summer Crenshaw, New York City, NY (US); Carisa Miklusak, New York City, NY (US); Solomon Pillersdorf, New York City, NY (US); Stephen Shefsky, New York City, NY (US)

(21) Appl. No.: 15/491,475

(22) Filed: Apr. 19, 2017

Related U.S. Application Data
(60) Provisional application No. 62/324,836, filed on Apr. 19, 2016.

(51) Int. Cl. G06Q 10/10; G06F 17/30

(52) U.S. Cl. CPC G06Q 10/1053; G06F 17/30867

(57) ABSTRACT

A method includes receiving a request associated with one or more attributes, the request representative of an opportunity for employment; querying a database to identify a record including the one or more attributes associated with the request; serving, to a computing device operated by a user associated with the identified record, a network resource providing the user with access to information about the request; and responsive to user interaction with the network resource, updating the identified record to indicate a relationship between the identified record and a record associated with the received request representative of the opportunity for employment.

### CLAIM OF PRIORITY

This application claims priority to U.S. Patent Application Ser. No. 62/324,836, filed on Apr. 19, 2016, the entire contents of which are incorporated here by reference.

### BACKGROUND

A user of a computing device can request a network resource to obtain information about an opportunity, such as an employment opportunity, for which he or she believes they are qualified. The network resource can be served to the computing device to provide the user with information and to enable to user to take actions to pursue the opportunity.

### SUMMARY

In an aspect, a method includes receiving a request associated with a first attribute, the request representative of an opportunity for employment; querying a database to identify a record including a second attribute satisfying the first attribute associated with the request; serving, to a computing device operated by a user associated with the identified record, a network resource providing the user with access to information about the request; and responsive to user interaction with the network resource, updating the identified record to indicate a relationship between the identified record and a record associated with the received request representative of the opportunity for employment.

Embodiments can include one or more of the following features.

The method includes updating the record associated with the received request to indicate the relationship between the identified record and the record associated with the received request.

The method includes querying the database to identify multiple records each including a second attribute satisfying the first attribute; and serving, to multiple computing devices each operated by a user associated with one of the identified multiple records, the network resource.

The method includes serving the network resource to the multiple computing devices concurrently.

Updating the identified record comprises updating the record associated with a first user to interact with the network resource.

The method includes serving the network resource to multiple computing devices sequentially.

The method includes serving the network resource to the multiple computing devices in an order based on a ranking of user records for the users operating the multiple computing devices.

The ranking of the user records is based on a score indicative of the second attribute of each record satisfying the first attribute.

Serving the network resource comprises serving the network resource to a first computing device; and after a predefined amount of time, serving the network resource to a second computing device.

Updating the identified record comprises updating the record associated with a user operating the second computing device.

Serving the network resource comprises serving the network resource to a first computing device; and responsive to user interaction with the network resource, serving the network resource to a second computing device.

Updating the identified record comprises updating the record associated with a user operating the second computing device.

The record associated with the received request includes multiple portion attributes, and in which the user interaction with the network resource includes a selection of one or more of the multiple portion attributes.

The method includes updating the record associated with the received request to indicate a relationship between the identified record and the selected one or more portions attributes.

The method includes updating the record associated with the received request to indicate a relationship between a second identified record and one or more other portion attributes.

The method includes updating a table to include a representation of the identified record.

The method includes updating a data storage to include one or more of an identifier of the identified record and a reference to the identified record.

The second attribute is the same as the first attribute.

The second attribute is different from the first attribute, and in which identifying the record includes querying an attributes database to determine that the second attribute is related to the first attribute.

In an aspect, a non-transitory computer readable medium stores instructions for causing a computing system to receive a request associated with a first attribute, the request representative of an opportunity for employment; query a database to identify a record including a second attribute satisfying the first attribute associated with the request; serve, to a computing device operated by a user associated with the identified record, a network resource providing the user with access to information about the request; and responsive to user interaction with the network resource, update the identified record to indicate a relationship between the identified record and a record associated with the received request representative of the opportunity for employment.

Embodiments can include one or more of the following features.

The instructions cause the computing system to update the record associated with the received request to indicate the relationship between the identified record and the record associated with the received request.

The instructions cause the computing system to query the database to identify multiple records each including a second attribute satisfying the first attribute; and serve, to multiple computing devices each operated by a user associated with one of the identified multiple records, the network resource.

The instructions cause the computing system to serve the network resource to the multiple computing devices concurrently.

Updating the identified record comprises updating the record associated with a first user to interact with the network resource.

The instructions cause the computing system to serve the network resource to multiple computing devices sequentially.

Serving the network resource comprises serving the network resource to a first computing device; and after a predefined amount of time, serving the network resource to a second computing device; and in which updating the identified record comprises updating the record associated with a user operating the second computing device.

Serving the network resource comprises serving the network resource to a first computing device; responsive to user interaction with the network resource, serving the network resource to a second computing device; and in which updating the identified record comprises updating the record associated with a user operating the second computing device.

The record associated with the received request includes multiple portion attributes, and in which the user interaction with the network resource includes a selection of one or more of the multiple portion attributes.

The instructions cause the computing system to update the record associated with the received request to indicate a relationship between the identified record and the selected one or more portions attributes.

The instructions cause the computing system to update the record associated with the received request to indicate a relationship between a second identified record and one or more other portion attributes.

### BRIEF DESCRIPTION OF DRAWINGS

FIG. 1 is a system diagram.

FIG. 2 is a diagram of a database.

FIGS. 3 and 4 are flow charts.

FIGS. 5-15B are screenshots of a user interface.

### DETAILED DESCRIPTION

We describe here an approach to providing network resources, e.g., web pages, pages of a mobile application, etc. to a user based on attributes associated with the user. A system receives a request associated with one or more attributes. Responsive to the request, the system queries a database storing user records, each user record associated with a corresponding user, to identify a user record having attributes that match the attributes associated with the received request. The system provides network resources to a user associated with the identified user record, the network resources providing the user with access to information about the request. For example, the network resources provided to the user can provide the user with access to information about the request. Based on user interaction with the network resources, the request can be associated with the user record associated with the user. For instance, the user record can be updated to reference a record associated with the request, such as to include a pointer to the record associated with the request.

In some examples, the request can be a request for a user possessing one or more qualification attributes associated with an available opportunity for employment, such as skill, tool, or certification attributes associated with the opportunity. The database storing user records can be queried to identify a user record associated with a user possessing the one or more qualification attributes indicated by the request. Network resources provided to the user associated with the identified user record can provide the user with access to information about the opportunity. The user record associated with the user can be updated based on user interaction with the network resources. For instance, the user record can be updated to indicate that the user provided an input accepting the opportunity.

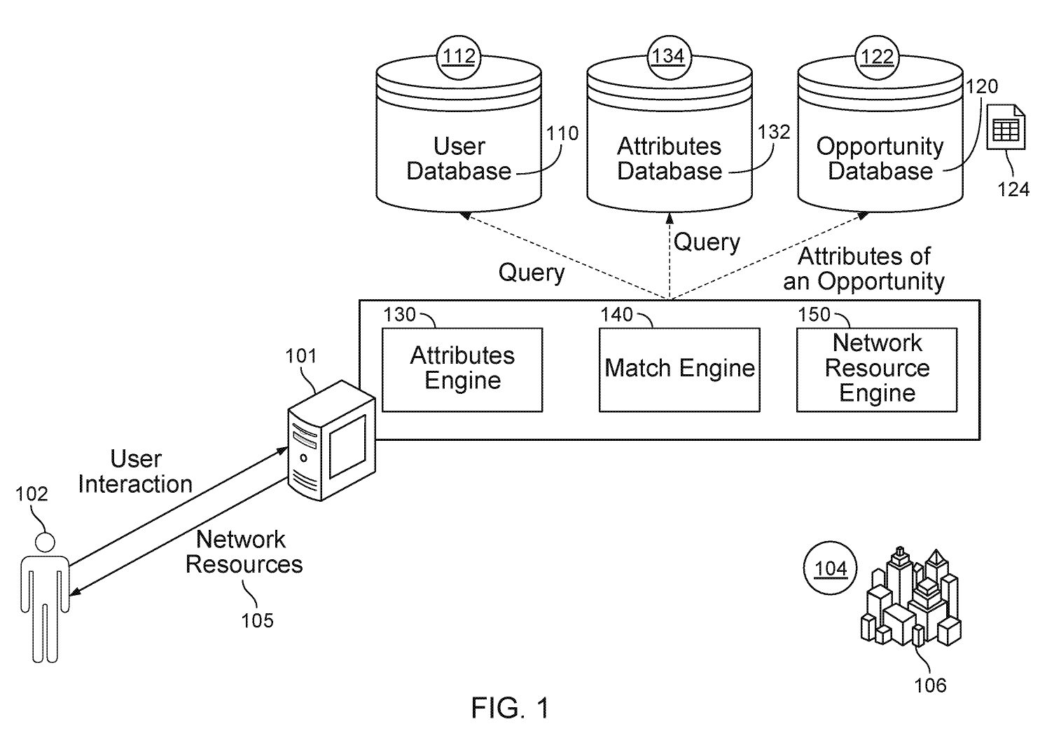

Referring to FIG. 1, a system 100 implemented by a server 101 enables a user 102 of the system 100 to be provided with network resources 105 associated with an opportunity 104 offered by an employer 106. An opportunity 104, for example, is an opportunity for employment with the employer 106. Each opportunity 104 represents an employment position (e.g., Barista, Administrative Assistant, Warehouse Clerk, or another position) having a specified schedule. An opportunity 104 can be a one-time occurrence (e.g., a Mail Clerk for Apr. 12, 2016, from 9 am-5 pm), a short-term recurring position (e.g., a Bartender from 6 pm-2 am from Apr. 1, 2016 to Apr. 8, 2016), a long-term recurring position (e.g., a Lifeguard from 10 am-6 pm from Jun. 1, 2016 to Sep. 1, 2016), or a permanent position (e.g., a Legal Secretary from 8 am-5 pm, Monday through Friday, beginning on May 2, 2016).

Each user 102 of the system 100 possesses a set of qualification attributes, such as skill, tool, and/or certification attributes the user has accumulated through education or previous or current employment experience. Each opportunity 104 offered through the system 100 is associated with a set of qualification attributes, such as skill, tool, and/or certification attributes, the employer 106 offering the opportunity expects that a person qualified for the opportunity will possess. The system 100 can automatically identify one or more users 102 that are qualified for a particular opportunity 104 based on a match between the qualification attributes (e.g., skill, certification, and/or tool attributes) possessed by each user 102 and the qualification attributes associated with the particular opportunity 104.

The server 101 can serve network resources 105 associated with the particular opportunity 104 to one or more of the users 102 identified as qualified for the opportunity. Through an interaction with the network resources 105, the user 102 can accept the opportunity 104 and complete pre-employment tasks for the opportunity, such as providing information for a background check, providing bank account routing information or tax information, or other tasks. The ability to accept the opportunity and complete related pre-employment tasks without human intervention, such as without intervention by a human resources professional, enables the user to be efficiently assigned to the opportunity and frees human resources professionals at the employer to focus on other tasks.

The server 101 can access a user database 110 that stores a user record 112 for each user 102. The user record 112 for a user 102 can be established upon enrollment of the user 102 with the system 100. The user record 112 for a particular user 102 can include biographical information about the user 102 (e.g., the user's name, address, email address, phone number, or other biographical information), information about the user's work history, information about the user's educational history, skills possessed by the user, a level of proficiency for each skill, certifications possessed by the user, tools at which the user is proficient, a level of proficiency for each tool, or other information. Information about the user's work history can include titles of jobs previously or currently held by the user, names of previous or current employers, or other information. Information about the user's educational history can include degrees earned by the user, degrees partially completed by the user, coursework completed or in progress, professional certifications, or other information.

In some examples, the user record 112 for a user 102 can include other attributes indicative of user preferences, such as location attributes (e.g., indicative of a geographical area the user prefers for his opportunities, a geographical area outside of which the user will not consider opportunities, or other location preferences), schedule attributes (e.g., indicative of preferred days or times for opportunities, days or times the user is unavailable for opportunities, or other schedule preferences), or other attributes. In some examples, the user record 112 can include information about opportunities previously completed by the user, such as the user's rating of a previous opportunity or an employer's rating of a user following completion of a previous opportunity (discussed below).

Some information stored in the user record 112 for a particular user 102 can be entered by the user. For instance, the user 102 can enter biographical information, work history or educational history information, user preferences, or other information. Some information stored in the user record 112 can be determined by the system 100, in conjunction with input from the user. For instance, an attributes engine 130 can identify the qualification attributes (e.g., skill, certification, and/or tool attributes) possessed by the user and/or a level associated with each qualification attribute (e.g., the level of proficiency for each skill or tool or the level of a multi-level certification achieved by the user) based on information about the user, such as based on the user's work history or educational history.

Additional description of the attributes engine can be found in co-pending U.S. application Ser. No. [Attorney Docket No. 43023-0002001], the contents of which are incorporated here by reference in their entirety. In some examples, a user can acquire qualification attributes through activities undertaken through the system 100, such as through completion of opportunities or education offered through the system 100. The attributes engine 130 can automatically update a user's user record 112 to reflect the qualification attributes acquired through the system.

The system 100 includes an opportunity database 120 that stores an opportunity record 122 for each available opportunity 104 in the system 100. The opportunity record 122 for a particular opportunity 104 can include the title of the position represented by the opportunity, information about the employer 106 offering the opportunity (e.g., the name of the employer, contact information for the employer, or other information), qualification attributes (e.g., skill, certification, or tool attributes) associated with the opportunity, a level of proficiency associated with each qualification attribute, a location attribute for the opportunity, a schedule attribute for the opportunity, a description of the opportunity (e.g., including text, images, video, or other types of data), or other information.

A match engine 140 identifies one or more users 102 as qualified for a particular opportunity 104 based on a match between the qualification attributes possessed by the users 102 and the qualification attributes associated with the opportunity 104. For instance, to identify users for a particular opportunity 104, the match engine 140 can query the user database 110 to identify those user records (e.g., record 112) having all of the qualification attributes included in the opportunity record 122 for the particular opportunity 104. In some examples, the opportunity record 122 for the particular opportunity includes a level of proficiency associated with one or more of the qualification attributes, and the match engine 140 can query the user database 110 to identify those user records (e.g., record 112) having all of the qualification attributes included in the opportunity record 122 and having the indicated level for each of the qualification attributes. We sometimes refer to user records (e.g., record 112) that have all of the qualification attributes included in the opportunity record 122 for a particular opportunity and having the indicated level of proficiency for each of the qualification attributes as user records 112 that are matched with the opportunity record.

In some examples, the match engine 140 can identify user records (e.g., record 112) that include all of the qualification attributes included in the opportunity record for a particular opportunity 104 and at the designated level as matches for the opportunity. In addition, the match engine 140 can identify one or more user records as imperfect matches for the opportunity. A user record (e.g., record 112) that is an imperfect match with an opportunity is a user record does not include all of the qualification attributes included in the opportunity record for the opportunity 104, or not at the designated level of proficiency, but is otherwise substantially similar. In an example, a user record that is an imperfect match with an opportunity may include all but one of the qualification attributes included in the opportunity record for the opportunity. In an example, a user record that is an imperfect match with an opportunity may include all of the qualification attributes included in the opportunity record for the opportunity, but may have at least one qualification attribute at a level of proficiency different from that designated in the opportunity record. User records that are imperfect matches for an opportunity can be flagged for review by an operator, such as a human resources professional, who can determine whether the user record may anyway be regarded as a match for the opportunity.

In some examples, the opportunity record 122 can include one or more rules that can be implemented to govern how a user record 112 is identified as a match for the opportunity 112 represented by the opportunity record 122. For instance, each of one or more qualification attributes associated with an opportunity is assigned a weighting factor to indicate its relative importance as compared with other qualification attributes associated with the opportunity. A user record (e.g., record 112) can be identified as a match for an opportunity 104 subject to the qualification attributes and associated weighting factors for the opportunity. In an example of a rule, if a user record is missing a highly weighted qualification attribute associated with an opportunity, the user record may not be identified as a match, but a user record missing a lower weighted qualification attribute may still be identified as a match. In an example of a rule, a score can be determined for a record based on the qualification attributes and associated weighting factors, and the record can be identified as a match if the score exceeds a threshold score. In an example of a rule, a score can be determined for each of multiple records based on the qualification attributes and associated weighting factors, and the record having the highest score can be identified as a match.

In some examples, the match engine 140 can rank the user record (e.g., record 112) based on the quality of the match with the opportunity record 122 for a particular opportunity. In some examples, the match engine 140 can rank the user records based on information stored in the user records indicative of previously completed opportunities. For instance, if the user record 112 for a particular user 102 includes a high rating from a particular employer or for a particular opportunity, the match engine 140 may rank that user record 112 highly for another opportunity from the same employer or for an otherwise similar opportunity from a different employer. Conversely, if the user record 112 for a particular user 102 includes a low rating from a particular employer or for a particular opportunity, the match engine 130 may assign a low ranking to that user record 112 for another opportunity from the same employer or for a similar opportunity from an otherwise similar different employer. In some examples, a positive rating from an employer to a user can be a highly weighted factor in determining a match between the user record and an opportunity record. If a user who was positively rated by an employer also positively rates the opportunity the user completed with the employer, this can be used to form a strong connection to potential future matches. In some examples, a negative rating submitted by a user to an opportunity offered by an employer may prevent the user from being matched with future opportunities offered by that employer. Similarly, a negative rating from an employer to a user may prevent the user from being matched with future opportunities offered by that employer. A neutral rating between an employer and a user or a user and an employer may increase the likelihood that the user may be matched with future opportunities offered by that employer to a degree less than that enabled by a positive rating but greater than that enabled by no rating.

In some examples, the match engine 140 can rank the user records 112 based on additional information about the users. For instance, in some cases, a user may need to work a minimum number of hours per week (e.g., 25 hours, 30 hours, 35 hours, 40 hours, or another number) in order to qualify for employer-sponsored health insurance offered by an administrator of the system 100. The match engine 140 can rank the user records in order to increase the number of users of the system 100 who are likely to work the minimum number of hours. For instance, between two equally qualified user records, the match engine 140 may assign a higher ranking to the user record belonging to a user who has not yet met his minimum hours and assign a lower ranking to the user record belonging to a user who has met his minimum hours.

In some examples, user records (e.g., record 112) identified as matched with an opportunity record are stored or indicated in a match table 124 associated with the opportunity record. The ranking of each user record 112 can be stored or indicated in the match table 124. For instance, the user records can be stored in order of ranking. In some examples, user records 112 identified as matched with an opportunity record can be tracked in another way, such as through a document storing identifiers of the user records or references (e.g., pointers) to the user records.

In some examples, the match engine 140 can identify one or more users for a particular opportunity 104 based on attributes other than qualification attributes (e.g., skill, tool, and/or certification attributes). For instance, the match engine 140 can query the user database 110 to identify those user records (e.g., record 112) having location or schedule attributes that are consistent with location or schedule attributes for the opportunity. In some examples, to identify users for a particular opportunity 104, the match engine 140 first queries the user database 110 to identify one or more user records 112 based on location and/or schedule attributes, and then identifies a subset of those user records having qualification attributes that are matched with the opportunity record 122 for the opportunity 104. In some examples, the match engine 140 first queries the user database 110 to identify one or more user records (e.g., record 112) having qualification attributes that are matched with the opportunity record 122 for a particular opportunity, and then identifies a subset of those user records based on location and/or schedule attributes.

A network resource engine 150 renders a network resource 105, such as a web page or a page of a mobile application, for presentation to one or more of the users 102 whose user record (e.g., record 112) was identified by the match engine 130. The network resource 105 can include information about the opportunity. The rendering of a network resource including information about an opportunity for presentation to a user is sometimes referred to as presenting the opportunity to the user. Through the network resource 105, the one or more users 102 are prompted to respond to accept or decline the opportunity 104. When an acceptance is received from a user 102, the user record 112 for the user 102 is updated to reflect that the user 102 is assigned to the opportunity. If a user declines the opportunity, the opportunity can be presented to another user.

In some examples, the opportunity 104 can be presented to some or all of the users 102 whose user record 112 was identified by the match engine 14. The first user 102 to accept the opportunity is assigned to the opportunity 104, and the opportunity is withdrawn from the other users 102. In some examples, the opportunity 104 can be presented to fewer than all of the users 102 whose user record was identified by the match engine 140. For instance, the opportunity can be presented to one or more users having highly ranked user records 112.

In some examples, the one or more users to whom an opportunity is presented are given a time limit within which to respond to the opportunity, e.g., to accept or decline the opportunity. If no response is received within the time limit, the notification engine 150 presents the opportunity to another one or more users. For instance, the opportunity can first be presented to the user having the highest ranked user record 112. If that user does not respond within the time limit for the opportunity, the opportunity is presented to the user having the second highest ranked user record. In some examples, the opportunity is presented concurrently to multiple users on a non-exclusive basis and the first user to respond with an acceptance is assigned the opportunity. For instance, if an employer urgently needs to fill an opportunity (e.g., because of an absentee employee, an absentee user who was supposed to fill the opportunity, a user who cancelled at the last minute, an opportunity with a short time horizon between time of posting and time of the opportunity, or for another reason), the opportunity can be offered to multiple users, such as a number (e.g., 5, 10, or another number) of users with the highest ranked user records.

When a user 102 accepts an opportunity 104, the user record 112 for the user and the opportunity record 122 for the opportunity are updated to indicate that the user is assigned to that opportunity. If no additional users are needed for the opportunity, the opportunity record for the opportunity can be updated to indicate that the opportunity is unavailable. If the opportunity is an opportunity for multiple users, the opportunity record indicates that the opportunity is available until the designated number of users have been assigned to the opportunity. The employer offering the opportunity can be notified that a user has been assigned to the opportunity and can be presented with information about the user, such as biographical information, information about the user's work or educational history, or ratings received by the user for previously completed opportunities, or other information.

In some examples, the network resources presented to the user can prompt the user for information associated with preparation for the opportunity, such as information sometimes handled by a human resources professional. For instance, information can be collected sufficient to facilitate a background check, information for direct deposit of pay with the user's bank, tax information, or other information. The approach of the system 100, in which the system enables the user 102 to accept the opportunity and complete related pre-employment tasks without human intervention, such as without intervention by a human resources professional, enables the user to be efficiently assigned to the opportunity and frees human resources professionals at the employer to focus on other tasks.

The approach of the system 100, in which users are identified as qualified for a particular opportunity based on matching of qualification attributes between the user's user record 112 and the opportunity record 122 for the opportunity, enables qualified users to be offered opportunities even if the opportunity differs from previous jobs the user has held. For instance, a qualified user may be offered an opportunity for a Wait Staff position even if the user has not previously worked as a waiter. Offering opportunities to qualified users enables efficient use of the labor pool of users in the system and helps to provide employment to users and to fill open positions with employers.

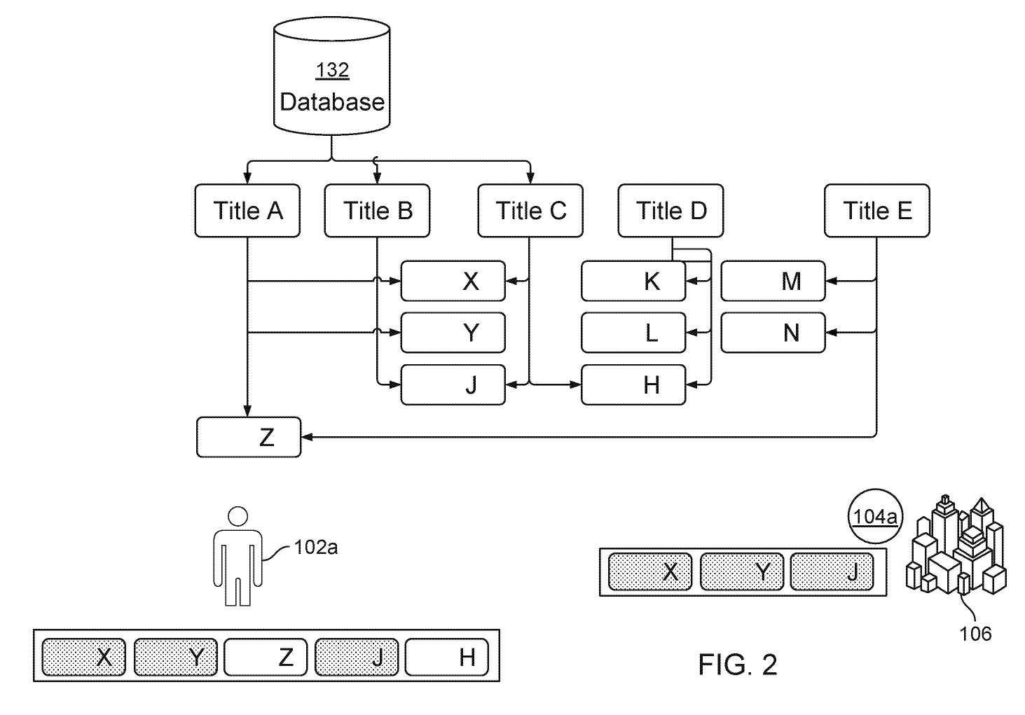

Referring to FIG. 2, in a specific example, the attributes database 132 includes job title records 134 for five job titles: Title A, Title B, Title C, Title D, and Title E. Each job title record 134 includes references to the qualification attributes associated with the job title of the record. For instance, the job Title A is associated with qualification attributes X, Y, and Z. The job Title B is associated with qualification attributes X, Y, and J. The job Title C is associated with qualification attributes X, J, and H. In a specific example, Titles A, B, and C may be Custodian, Housecleaner, and Gardener, respectively. The qualification attribute X may be “Manual labor,” the qualification attribute Y may be “Cleaning,” the qualification attribute Z may be “Facilities management,” the qualification attribute J may be “Managing client expectations,” and the qualification attribute H may be “Working outdoors.”

In this example, a user 102a has worked in a Title A role (e.g., Custodian) and a Title C role (e.g., Gardener) and has indicated (e.g., during an enrollment process) that he has acquired all of the qualification attribute associated with these two roles. The worker 102a thus possesses the qualification attributes X (Manual labor), Y (Cleaning), Z (Facilities management), J (Managing client expectations), and H (Working outdoors). Although the user has never worked in a Title B role (e.g., Housecleaner), the match engine 140 identifies the user 102a as qualified for an opportunity 104a in a Title B role because the user 102a possesses all of the qualification attributes associated with the Title B role.

In some examples, the matching of skill attributes can be based on linked skill attributes. Skill attributes can be linked in the attribute database 132 if the two skills are substantially equivalent. If the user 102a does not possess a specific skill attribute associated with the opportunity 104a but does possess a different skill attribute that is linked to that specific skill attribute, the user 102a may be identified as qualified for the opportunity 104a.

In the example of FIG. 2, the user 102a is identified as qualified for the opportunity 104a based on a comparison between the qualification attributes possessed by the user 102a and the qualification attributes associated with the opportunity 104a. In some examples, other criteria can be used in addition matching of qualification attributes to determine whether the user 102a is to be offered the opportunity 104a. For instance, the user's location or schedule attributes or the user's previous experiences in opportunities offered through the system can be taken into account, e.g., as described above.

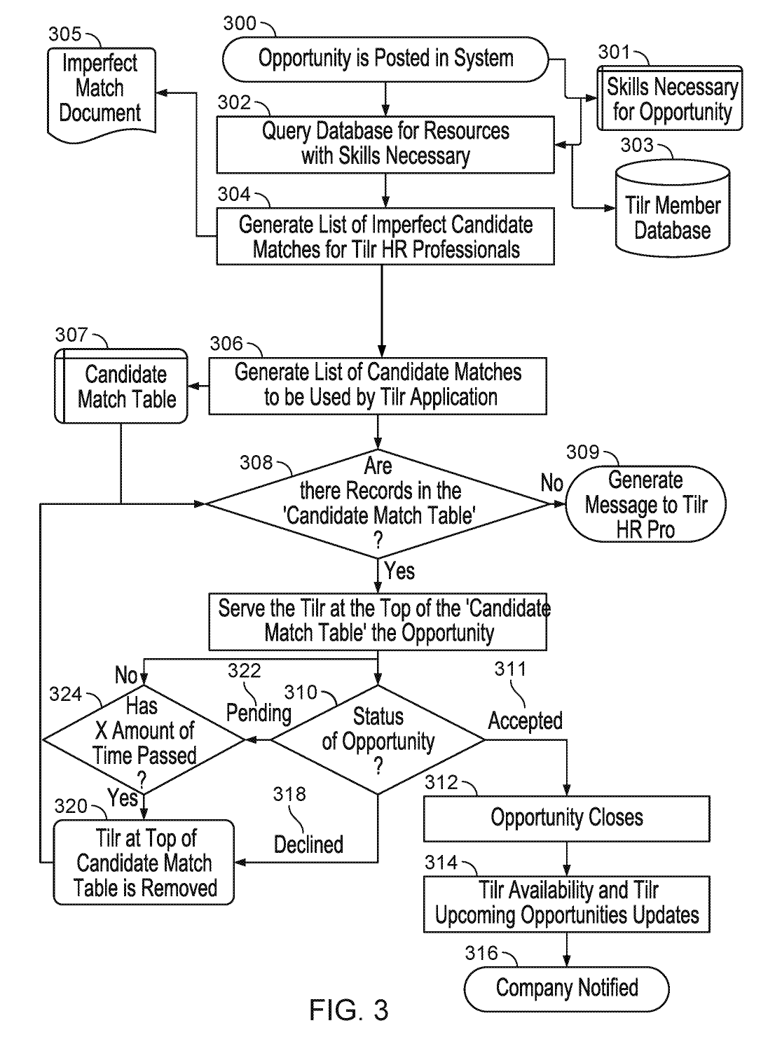

Referring to FIG. 3, in an example process, an opportunity associated with one or more qualification attributes 301 is offered through the system (300). A query is undertaken to identify user records in a user database 303 having qualification attributes that match the qualification attributes associated with the opportunity (302), in some cases at the designated level of proficiency for each qualification attribute.

A list 305 is generated (304) of any user records that are imperfect matches for the opportunity. A user record that is an imperfect match with an opportunity is a user record does not include all of the qualification attributes included in the opportunity record for the opportunity, or not at the designated level of proficiency, but is otherwise substantially similar. User records that are designated as imperfect matches for an opportunity can be reviewed by an operator, such as a human resources professional, who can determine whether the user record may anyway be regarded as a match for the opportunity.

Any user records identified as matching with the opportunity are stored or referenced (306) in a table 307. If the table 307 is empty (308), no user records have been identified as matching the opportunity, and an alert message is generated (310). The alert message can be provided to a system operator, such as a human resources professional, or to the employer offering the opportunity, or to another recipient.

If there are user records in the table 307 (308), the opportunity is presented to one or more of the users associated with the user records in the table 307. In the example of FIG. 3, the opportunity is presented to the user associated with the highest ranking user record. In some examples, the opportunity can be presented to multiple users, such as multiple high ranking users. The user to whom the opportunity is presented is prompted to respond, e.g., to accept or decline the opportunity. The user's response defines the status of the opportunity (310). If there are no user records in the table 307, a message is generated to a system administrator (309).

If the user accepts the opportunity (311), the user is assigned to the opportunity. The opportunity record is updated to reflect that the opportunity is unavailable (312), and the opportunity record and the user record are both updated to reflect that the user has been assigned to the opportunity (314). The employer offering the opportunity is notified (316) that the opportunity has been filled. In some examples, the employer is provided with information about the user assigned to the opportunity, such as biographical information, information about the user's work or educational history, information about opportunities previously completed by the user, or other information.

If the user declines the opportunity (318), that user's user record is removed (320) from the table 307 of matched user records. If there are other user records remaining in the table 307 (308), the opportunity is presented to one or more users associated with the remaining user records in the table 307, such as the next highest ranking user.

If no response has been received from the user (322), the opportunity is still pending. In some examples, the user is given a time limit within which to respond to the opportunity. If the time limit has not been exceeded (324), the system continues to wait for the user's response. If the time limit has been exceeded, the user loses his chance to accept the opportunity. The user's user record is removed (320) from the table 307 of matched user records. If there are other user records remaining in the table 307 (308), the opportunity is presented to one or more users associated with the remaining user records in the table 307, such as the next highest ranking user.

In some examples, the user to whom the opportunity is presented is able to accept only a portion of the opportunity. The remaining portion(s) of the opportunity can be presented to one or more other users, such that a single opportunity can be shared among multiple users. An opportunity that can be shared among multiple users is referred to as a sharable opportunity. In an example, for a sharable opportunity that spans a range of time (e.g., 9 am to 5 pm or Monday-Friday), a user can accept the opportunity for less than all of the time range, and the remainder of the time range can be presented to one or more other users. For instance, for a sharable opportunity that spans 9 am to 5 pm on a single day, a first user may accept the opportunity for 9 am to 12 pm, and the remaining time (12 pm to 5 pm) can be presented to one or more other users. For a sharable opportunity that spans Monday through Friday, a first user may accept the opportunity for Monday, Thursday, and Friday, and the remaining days (Tuesday and Wednesday) can be presented to one or more other users.

The opportunity record for a given opportunity can include a sharing attribute indicative of whether, and how, the opportunity can be split among multiple users. If the sharing attribute for a given opportunity indicates that the opportunity is a sharable opportunity, then the user to whom the opportunity is presented is presented with the option to accept the entire opportunity or to accept only a portion of the opportunity.

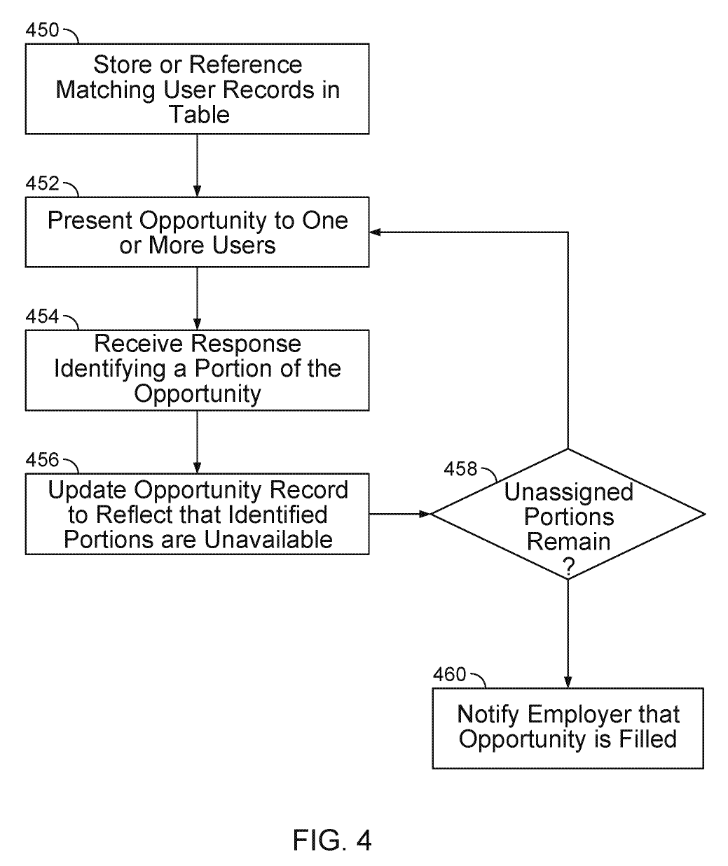

Referring to FIG. 4, in an example process, a sharable opportunity is offered through the system. Multiple user records identified as matching with the opportunity are stored or referenced in a table (450), e.g., as described above. The opportunity is presented to one or more of the users associated with the user records in the table (452). Presentation of the opportunity includes presenting the user with an option to accept the entire opportunity and an option to accept only a portion of the opportunity, according to the sharing attribute associated with the opportunity. For instance, the sharing attribute can indicate how the opportunity can be divided into portions, e.g., by day, by hour, or in another way.

The user's response includes an identification of the portion(s) of the opportunity the user has accepted and is used to define the status of the opportunity (454). The opportunity record is updated to reflect that the portion(s) of the opportunity accepted by the user are unavailable (456), and the opportunity record and the user record are both updated to reflect that the user has been assigned to those portions of the opportunity.

If one or more portions of the opportunity are still unassigned (458), those portions of the opportunity are presented to users associated with one or more of the other user records in the table (452). If all of the portions of the opportunity are assigned (458), e.g., the user accepted the entire opportunity or multiple users each accepted one or more portions of the opportunity, the employer offering the opportunity is notified that the opportunity has been filled (460).

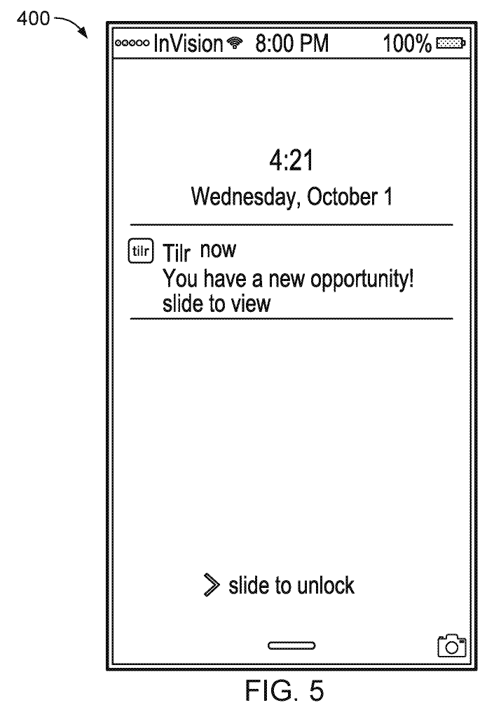

FIGS. 5-9 are screenshots of an example user interface through which a user can view information about an opportunity with which he has been matched. Through the user interface, the user can accept or decline the opportunity with little human intervention, e.g., with no direct contact with a human resources department at the employer offering the opportunity. This approach, in which the user is enabled to accept or decline an opportunity without human intervention, such as without intervention by a human resources professional, enables the user to be efficiently assigned to the opportunity and frees human resources professionals at the employer to focus on other tasks. In the example of FIGS. 5-9, the user interface is the interface of a mobile computing device (e.g., a smartphone). In some examples, the user interface can be the display screen of another type of computing device, such as a desktop or laptop computer.

Referring to FIG. 5, when a user is identified as a match for an opportunity, e.g., based on a match between the user's qualification attributes and the qualification attributes associated with the opportunity, a notification 400 is presented to the user. In the example of FIG. 5, the notification 400 is a push notification that is displayed on a home screen of a mobile computing device. In some examples, the notification 400 can be a sound, a vibration, a text message, an email, an alert within a mobile application for the system, or another type of notification. In some examples, the type of notification is set by the system. In some examples, each user can specify a preference for the type of notification he would like to receive.

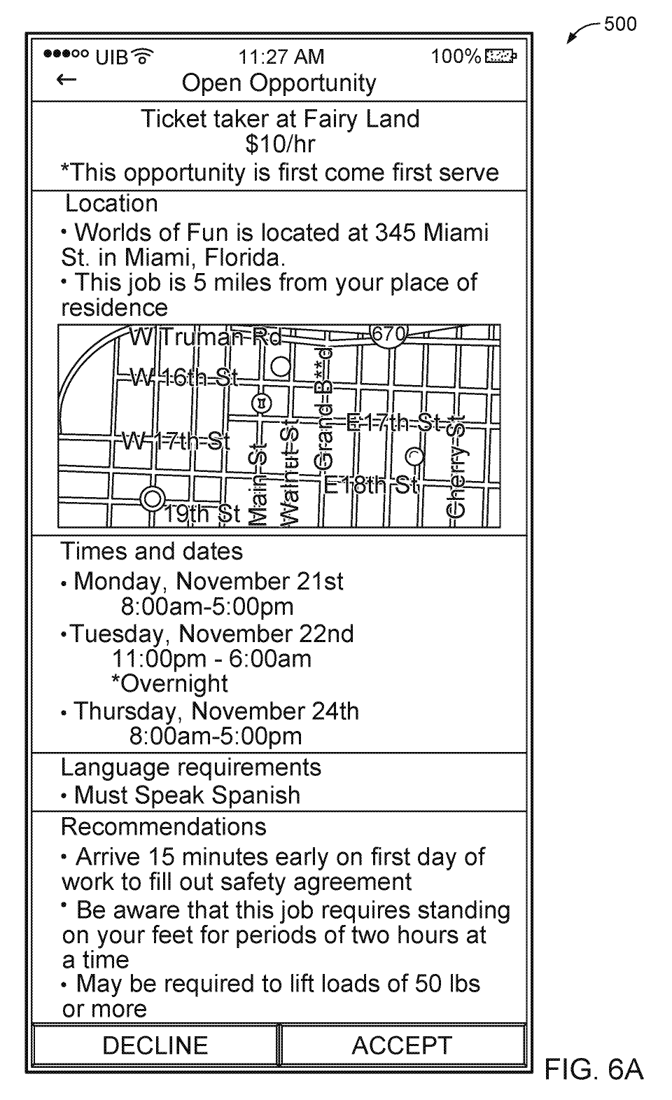

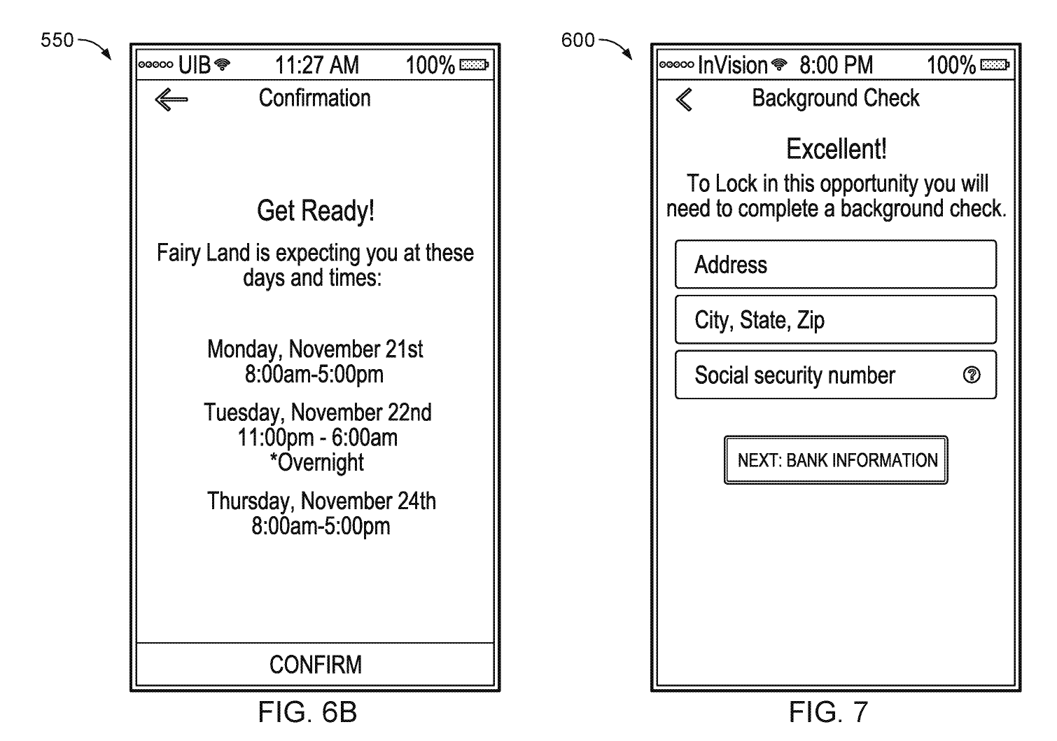

Referring to FIG. 6A, the user can access information about the opportunity with which he has matched through a view 500 in the mobile application (as shown) or through the user interface of another type of computing device. The view 500 can include information about the opportunity, such as the title of the position, the pay rate, the name of the employer, the location and schedule of the opportunity, requirements for the opportunity such as language requirements, a dress code, or a list of items to bring, or other information about the opportunity. The user can accept the opportunity directly through the view 500, without interaction with a human associate with the system or the employer. The worker is automatically scheduled for the opportunity at the specified times via a straightforward, efficient interaction with the view 500. Referring to FIG. 6B, once the user has accepted the opportunity, a view 550 displaying a confirmation of the schedule of the opportunity is displayed and the user is prompted to confirm his acceptance of the schedule.

In some examples, the user to whom the opportunity is presented is given a time limit within which to respond to the opportunity, e.g., to accept or decline the opportunity. In some examples, the opportunity is presented concurrently to multiple users and the first user to respond with an acceptance is assigned the opportunity.

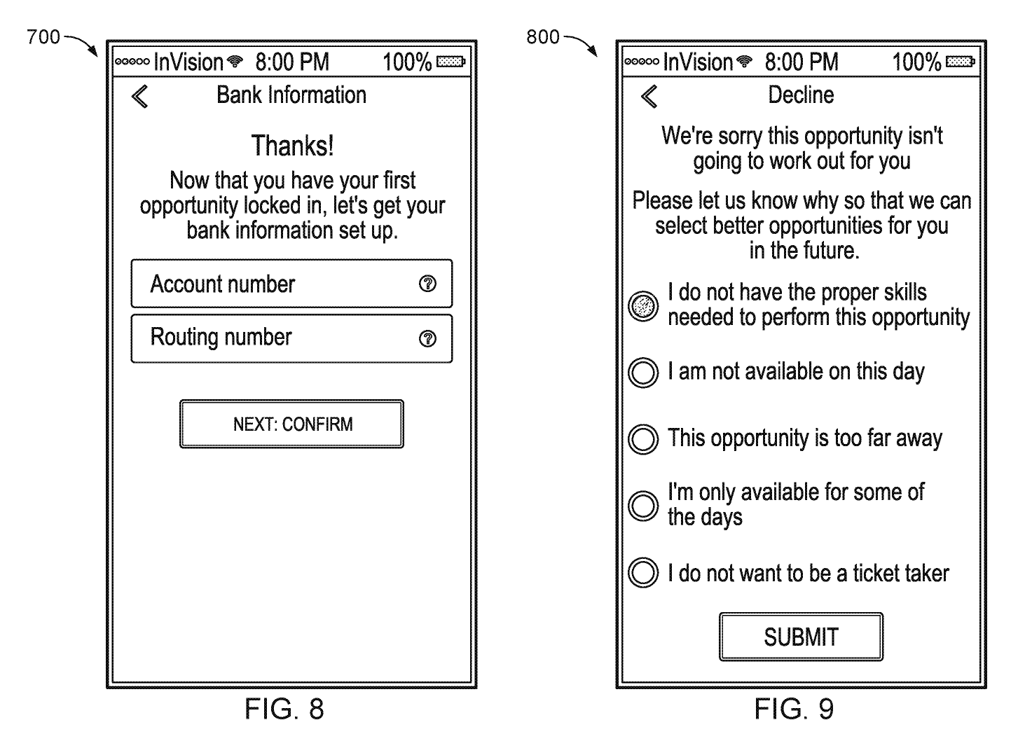

Referring to FIGS. 7 and 8, in some examples, prior to the user beginning an opportunity, the user is asked to complete additional enrollment steps, such as providing information to facilitate a background check (through a view 600), information for direct deposit of pay with the user's bank (through a view 700), tax information, or other information. In some examples, one or more of these enrollments steps are completed during the registration process rather than after an opportunity has been offered to the user. In some examples, one or more of these enrollment steps is not relevant for a particular opportunity. For instance, some employers may not request a background check, or some employers may pay a user with a check rather than through direct deposit.

The ability to complete related pre-employment tasks without human intervention, such as without intervention by a human resources professional, enables the user to efficiently complete these tasks and frees human resources professionals at the employer to focus on other tasks.

Referring to FIG. 9, the user may choose to decline an opportunity, e.g., if he does not like the opportunity, if he is not available for the scheduled hours, or for another reason. If the user declines an opportunity, the user can enter an explanation of his reasons for having declined through a view 800. In some examples, the user's explanation can be used by the system in matching the worker with future opportunities, e.g., so that future opportunities presented to the user are more likely to be accepted. For instance, if the user indicates that the opportunity is too far away, the system may update the location criteria stored in the user's record. If the user indicates that he does not want to be a ticket taker, the system may store in the user's record an indication that future ticket taker opportunities are not to be presented to that user.

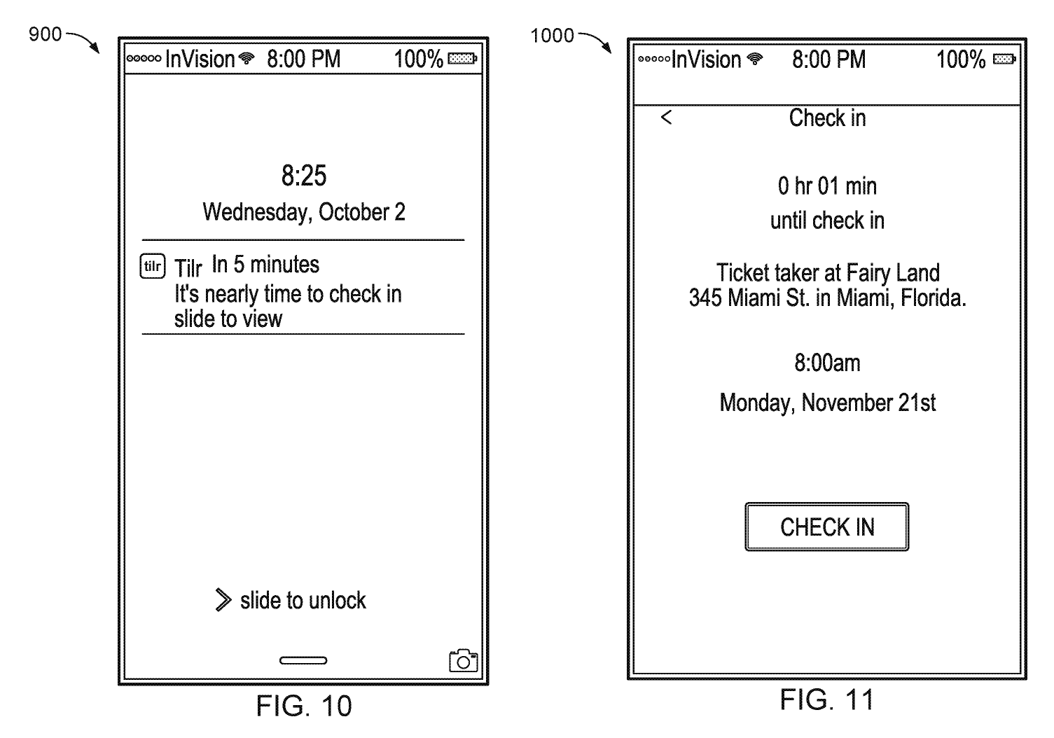

FIGS. 10-12 are screenshots of an example user interface with which the user can interact at the time of the opportunity. Through the user interface, the user can check into the opportunity to indicate that he has arrived and is ready to work; and check out of the opportunity to indicate that he has completed his shift. The check in and check out processes can be completed without intervention by the employer, such as without intervention by a supervisor or a human resources professional, thus freeing those professionals to focus on other tasks. In the example of FIGS. 10-12, the user interface is the interface of a mobile computing device (e.g., a smartphone). In some examples, the user interface can be the display screen of another type of computing device, such as a desktop or laptop computer.

Referring to FIG. 10, at or before the scheduled time for the opportunity, a notification 900 can be presented to the user. In the example of FIG. 9, the notification 900 is a push notification that is displayed on a home screen of a mobile computing device. In some examples, the notification 900 can be a sound, a vibration, a text message, an email, an alert within a mobile application for the system, or another type of notification. In some examples, the type of notification is set by the system. In some examples, each user can specify a preference for the type of notification he would like to receive. In some examples, the user can specify a preference for the timing of the notification, such as how far in advance of the opportunity the notification is to be provided.

Referring to FIG. 11, at the time of the opportunity, the user is prompted to check into the opportunity via a view 1000. When the user checks into the opportunity, the user's status in the user database is updated to indicate that the user is present at the opportunity. In some examples, the user is enabled to check into the opportunity when his location (e.g., as determined by GPS, WiFi, or another positioning technology) matches the location of the opportunity. Location-based check-in prevents a user from checking into an opportunity before he has actually arrived on site. In some examples, the user can be automatically checked into the opportunity when his location matches the location of the opportunity.

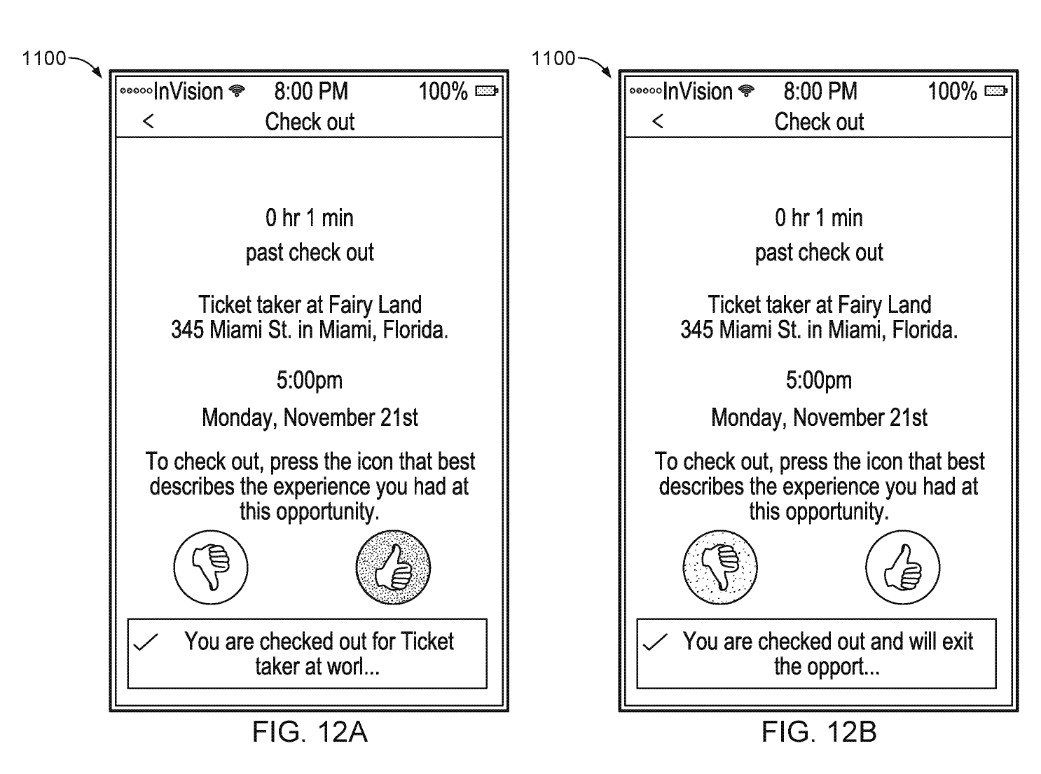

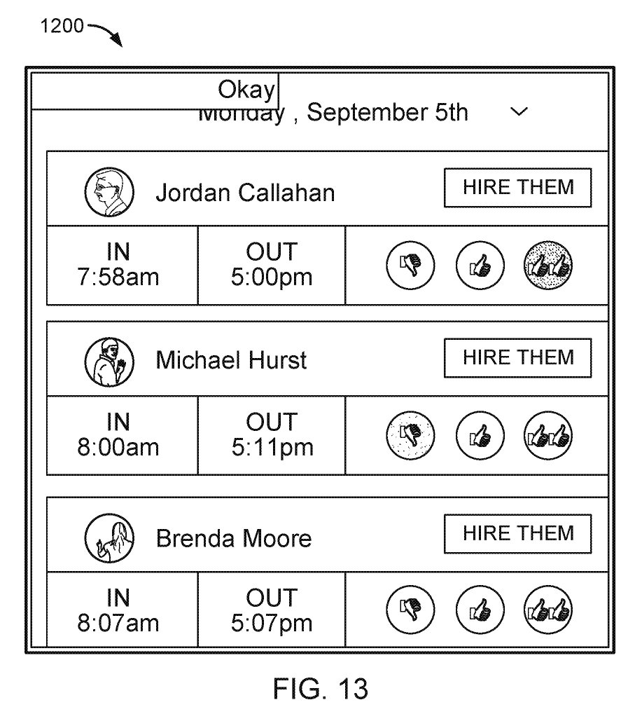

Referring to FIGS. 12A and 12B, at the end of the opportunity, the user is prompted to check out of the opportunity via a view 1100. In some examples, the user is prompted to rate his experience at the opportunity. In the example of FIGS. 12A and 12B, the user is presented with two rating options: a positive rating and a negative rating. In some examples, additional rating options can be available, such as three or more rating options. In some examples, the user's rating of an opportunity can influence the future opportunities presented to the user. For instance, if the user assigns a positive rating to the opportunity (as shown in FIG. 12A), the system may be more likely to present similar opportunities to the user in the future, such as opportunities with the same employer, with the same or a related title, with the same or similar set of qualification attributes, or otherwise similar opportunities. Conversely, if the user assigns a negative rating to the opportunity (as shown in FIG. 12B), the system may be less likely to present similar opportunities to the user in the future. In some examples, if the user assigns a negative rating to the opportunity, the user is exempted from any remaining occurrences of the opportunity. For instance, if the user assigns a negative rating to an opportunity scheduled for five consecutive days, the user is exempted from any remaining days of the opportunity.

FIGS. 13-15 are screenshots of an example user interface through which an employer can access information about users assigned to an opportunity offered by the employer. Through the user interface, the employer can access a list of the users scheduled to report or already reported for an opportunity and can access information about each user, such as information about a user's work or educational history, skills, certifications, tools, or ratings received for previously completed opportunities. When a user completes the opportunity, the employer is prompted to rate the user, which information can be used to assign future opportunities to the user. In the example of FIGS. 13-15, the user interface is the interface of a computing device, such as a desktop or laptop computer. In some examples, the user interface can be the interface of a mobile computing device.

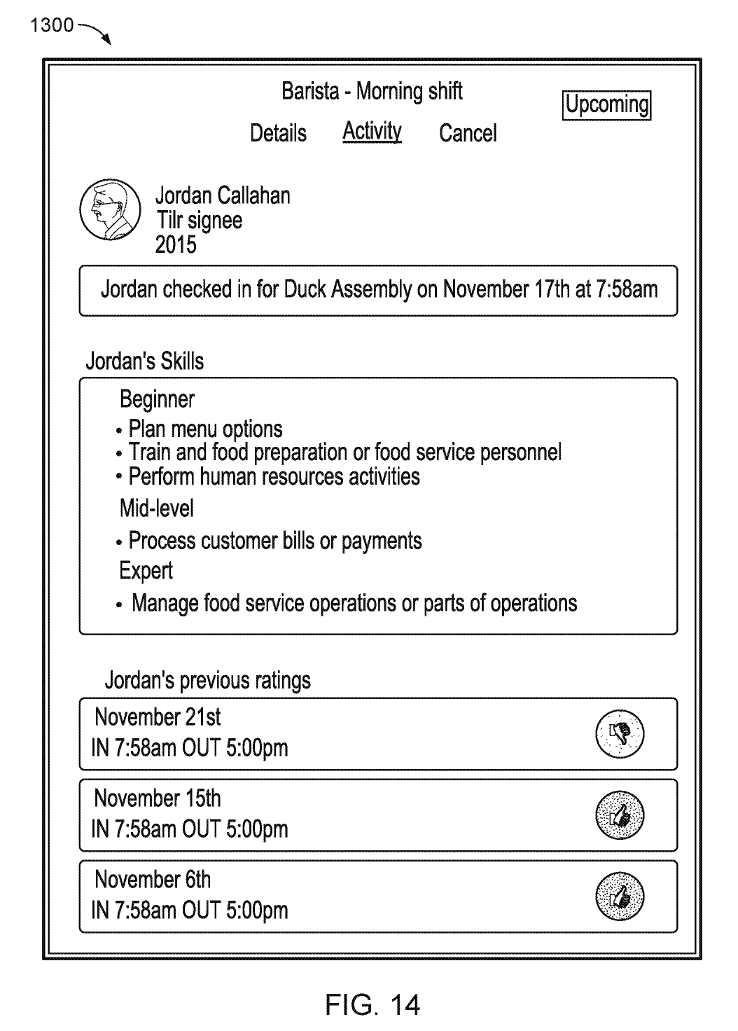

Referring to FIG. 13, the employer can access a list of the users assigned to the “Barista—Morning shift” opportunity through a view 1200. The view 1200 shows which assigned users have checked into or out of the opportunity. Referring to FIG. 14, the employer can select a user to view detailed information about the user through a view 1300. In some examples, the view 1300 for a given user can show information such as the user's skills and level of proficiency for each skill, previous opportunities completed by the user, the rating the user received at his previous opportunities, or other information about the user. In some examples, the view 1300 can also show information about the user's certifications and tools.

Referring again to FIG. 13, after a user checks out of an opportunity, the employer is prompted to rate the user through a view 1400. In the example of FIG. 13, the employer is presented with three rating options: a positive rating and a negative rating. In some examples, other numbers of rating options can be available, such as two rating options or four or more rating options. In some examples, the employer's rating of a worker can influence future opportunities presented to the user. For instance, if the employer assigns a positive rating to a user, the system may be more likely to present similar opportunities to the user in the future, such as opportunities with the same employer, with the same or a related title, with the same or similar set of qualification attributes, or otherwise similar opportunities. Conversely, if the employer assigns a negative rating to a user, the system may be less likely to present similar opportunities to the user in the future. In some examples, if the employer assigns a negative rating to the user, the user may be exempted from any remaining occurrences of the opportunity. In some examples, the user may be given the option to hire the worker as a permanent employee. If the user is hired, the user's user record can be migrated to an employer-specific system, e.g., as described in U.S. application Ser. No. [Attorney Docket No. 43023-0005001].

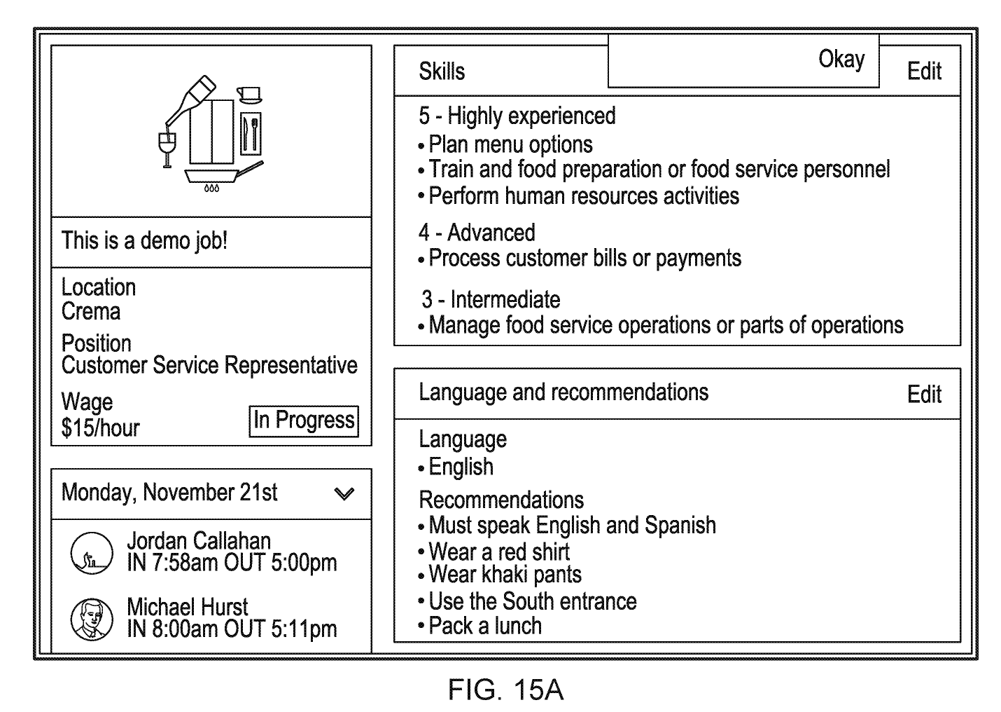

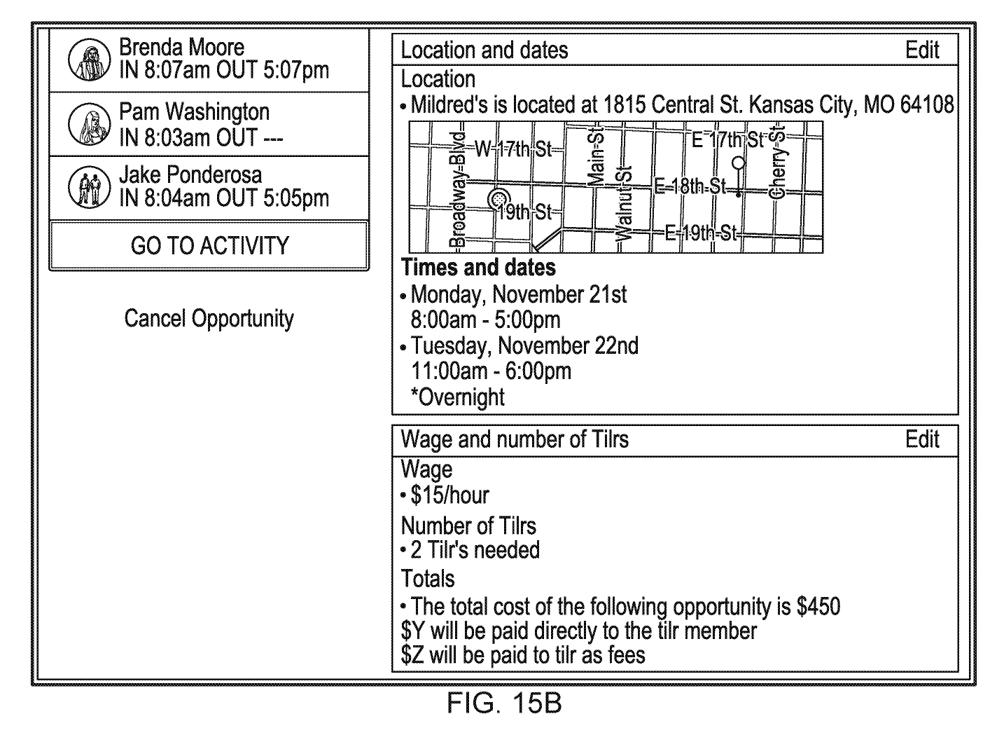

Referring to FIGS. 15A and 15B, in some examples, a summary view 1500 for an opportunity can be available that shows qualification attributes, other attributes such as language, schedule, and location attributes, wage, and the names and in or out time of the workers hired for the opportunity.

Other implementations are also within the scope of the following claims.

What is claimed is:

1. A method comprising:
receiving a request associated with a first attribute, the request representative of an opportunity for employment;
querying a database to identify a record including a second attribute satisfying the first attribute associated with the request;
serving, to a computing device operated by a user associated with the identified record, a network resource providing the user with access to information about the request; and
responsive to user interaction with the network resource, updating the identified record to indicate a relationship between the identified record and a record associated with the received request representative of the opportunity for employment.

2. The method of claim 1, comprising updating the record associated with the received request to indicate the relationship between the identified record and the record associated with the received request.

3. The method of claim 1, comprising:
querying the database to identify multiple records each including a second attribute satisfying the first attribute; and
serving, to multiple computing devices each operated by a user associated with one of the identified multiple records, the network resource.

4. The method of claim 3, comprising serving the network resource to the multiple computing devices concurrently.

5. The method of claim 4, in which updating the identified record comprises updating the record associated with a first user to interact with the network resource.

6. The method of claim 3, comprising serving the network resource to multiple computing devices sequentially.

7. The method of claim 6, comprising serving the network resource to the multiple computing devices in an order based on a ranking of user records for the users operating the multiple computing devices.

8. The method of claim 7, in which the ranking of the user records is based on a score indicative of the second attribute of each record satisfying the first attribute.

9. The method of claim 6, in which serving the network resource comprises;
serving the network resource to a first computing device; and
after a predefined amount of time, serving the network resource to a second computing device.

10. The method of claim 9, in which updating the identified record comprises updating the record associated with a user operating the second computing device.

11. The method of claim 6, in which serving the network resource comprises:
serving the network resource to a first computing device;
responsive to user interaction with the network resource, serving the network resource to a second computing device.

12. The method of claim 11, in which updating the identified record comprises updating the record associated with a user operating the second computing device.

13. The method of claim 1, in which the record associated with the received request includes multiple portion attributes, and in which the user interaction with the network resource includes a selection of one or more of the multiple portion attributes.

14. The method of claim 13, including updating the record associated with the received request to indicate a relationship between the identified record and the selected one or more portions attributes.

15. The method of claim 14, comprising updating the record associated with the received request to indicate a relationship between a second identified record and one or more other portion attributes.

16. The method of claim 1, comprising updating a table to include a representation of the identified record.

17. The method of claim 1, comprising updating a data storage to include one or more of an identifier of the identified record and a reference to the identified record.

18. The method of claim 1, in which the second attribute is the same as the first attribute.

19. The method of claim 1, in which the second attribute is different from the first attribute, and in which identifying the record includes querying an attributes database to determine that the second attribute is related to the first attribute.

20. A non-transitory computer readable medium storing instructions for causing a computing system to:
receive a request associated with a first attribute, the request representative of an opportunity for employment;
query a database to identify a record including a second attribute satisfying the first attribute associated with the request;
serve, to a computing device operated by a user associated with the identified record, a network resource providing the user with access to information about the request; and
responsive to user interaction with the network resource, update the identified record to indicate a relationship between the identified record and a record associated with the received request representative of the opportunity for employment.

21. The non-transitory computer readable medium of claim 20, the instructions causing the computing system to update the record associated with the received request to indicate the relationship between the identified record and the record associated with the received request.

22. The non-transitory computer readable medium of claim 20, the instructions causing the computing system to:
query the database to identify multiple records each including a second attribute satisfying the first attribute; and
serve, to multiple computing devices each operated by a user associated with one of the identified multiple records, the network resource.

23. The non-transitory computer readable medium of claim 22, the instructions causing the computing system to serve the network resource to the multiple computing devices concurrently.

24. The non-transitory computer readable medium of claim 23, in which updating the identified record comprises updating the record associated with a first user to interact with the network resource.

25. The non-transitory computer readable medium of claim 22, the instructions causing the computing system to serve the network resource to multiple computing devices sequentially.

26. The non-transitory computer readable medium of claim 25, in which serving the network resource comprises;
serving the network resource to a first computing device; and
after a predefined amount of time, serving the network resource to a second computing device; and
in which updating the identified record comprises updating the record associated with a user operating the second computing device.

27. The non-transitory computer readable medium of claim 25, in which serving the network resource comprises:
serving the network resource to a first computing device;
responsive to user interaction with the network resource, serving the network resource to a second computing device; and
in which updating the identified record comprises updating the record associated with a user operating the second computing device.

28. The non-transitory computer readable medium of claim 20, in which the record associated with the received request includes multiple portion attributes, and in which the user interaction with the network resource includes a selection of one or more of the multiple portion attributes.

29. The non-transitory computer readable medium of claim 28, the instructions causing the computing system to update the record associated with the received request to indicate a relationship between the identified record and the selected one or more portions attributes.

30. The non-transitory computer readable medium of claim 29, the instructions causing the computing system to update the record associated with the received request to indicate a relationship between a second identified record and one or more other portion attributes.
